(19) United States
(12) Patent Application Publication
(10) Pub. No.: US 2009/0020557 A1
(43) Pub. Date: Jan. 22, 2009

(54) Protective spray

(76) Inventor: Betty Jean Kemp, Murfreesboro, TN (US)

Correspondence Address: JAMES RAY & ASSOCIATES, 2640 PITCARN ROAD, MONROEVILLE, PA, 15146, US

(21) Appl. No.: 12/218,321

(22) Filed: Jul. 14, 2008

Related U.S. Application Data
(60) Provisional application No. 60/950,347, filed on Jul. 18, 2007.

(51) Int. Cl. B67D 5/00; B67D 5/06

(52) U.S. Cl. 222/79; 222/478

(57) ABSTRACT

An apparatus for providing a form of defense and protection from would be assailants. The apparatus comprises a spraying dispenser having a predetermined shape and formed of a predetermined material. There is a multi component liquid disposed within the spraying dispenser, such multi component liquid including a staining material and, further, includes a pungent odor carrying component that is disposed in the multi component liquid for providing a long lasting smell on such assailant when sprayed with such multi component liquid.

### CROSS REFERENCE TO RELATED APPLICATIONS

This application is closely related to and claims benefit from U.S. Provisional Application Ser. No. 60,950,347 filed Jul. 18, 2007.

### FIELD OF THE INVENTION

The present invention relates, in general, to a protective spray, and, more particularly, the present invention relates to a two component liquid which when sprayed on an assailant covers them with a stain and produces a pungent odor so that such assailant has a long lasting stain and a long lasting pungent odor.

### BACKGROUND OF THE INVENTION

When someone is victim to an act of violence or an attack, any means of survival is crucial. Showing any kind of physical resistance can deter the attacker and, possibly save that person's life. For people who worry about the horror stories they hear and see on television or the newspaper, a spray may offer some sort of protection. Such a spray would allow the person who may hold themselves captive to irrational fears to be able to go out and engage the world without restraint or concern. For people who have already experienced such an attack, or other life threatening situations, such a spray may provide the psychological tool that enables them to live less constrained. Social anxieties are fairly common in former attack victims and may have crippling effect on their ability too travel to populated areas because crime is a reality in all societies, a person may want to carry a non-lethal means of protection with them,

Thus, it would be advantageous if there were a simple and effective spray means that would mark the attacker with a long lasting stain and/or cover the attacker with a long lasting pungent odor that is difficult to remove.

### SUMMARY OF THE INVENTION

In a first aspect the present invention provides an apparatus for providing a form of defense and protection from would be assailants. The apparatus comprises a spraying dispenser having a predetermined shape and formed of a predetermined material. There is a multi component liquid disposed within the spraying dispenser, such multi component liquid including a staining material and, further, includes a pungent odor carrying component that is disposed in the multi component liquid for providing a long lasting smell on such assailant when sprayed with such multi component liquid.

### OBJECTS OF THE INVENTION

It is, therefore, one of the primary objects of the present invention to provide an apparatus for spraying an assailant.

Another object of the present invention is to provide an apparatus for spraying an assailant that includes a stain material.

Still another object of the present invention is to provide an apparatus for spraying an assailant wherein such staining material is a reflective paint than can be seen clearly in the daylight and that glows in the dark.

Yet another object of the present invention is to provide an apparatus for spraying an assailant that further includes a pungent odor carrying material which produces a strong skunk like odor.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of a canister type dispenser showing the spray nozzle for spraying an assailant and the optional victim spray.

FIG. 2 is a is a side perspective view of a fake gun used as the spraying apparatus.

FIG. 3 is a side perspective view of other items that can be used as a spraying mechanism such as a pen, a water bottle, a household spray and a baby shampoo bottle.

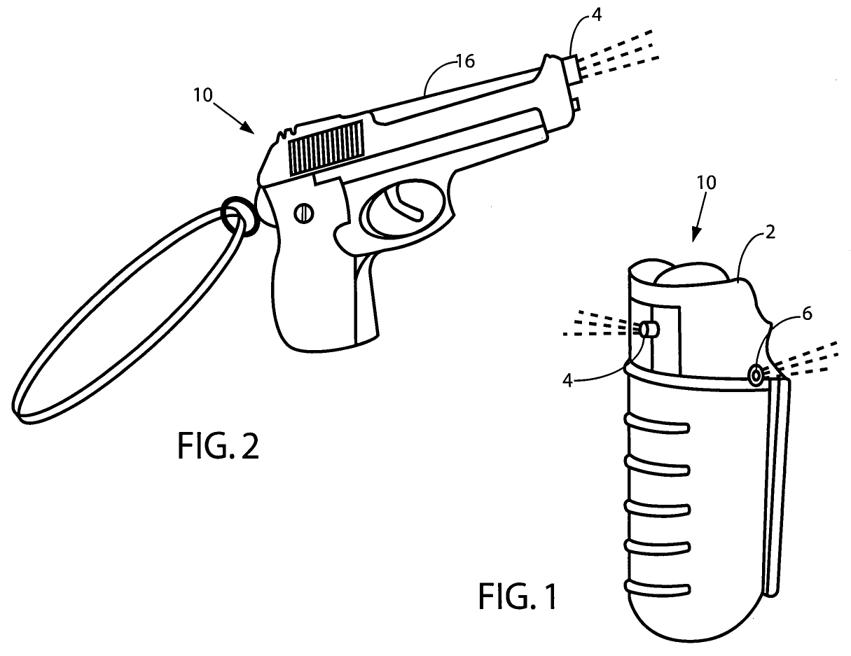

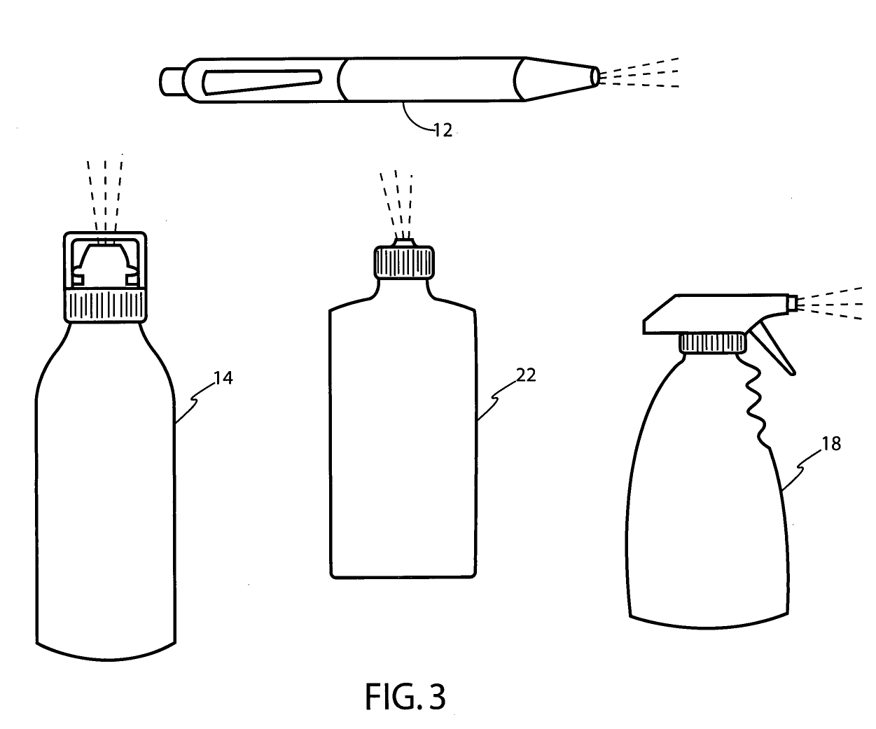

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing a form of defense and protection from would be assailants. The apparatus 10 comprises a spraying dispenser 2 having a predetermined shape and formed of a predetermined material. There is a multi component liquid disposed within the spraying dispenser 2, such multi component liquid including a staining material and, further, includes a pungent odor carrying component that is disposed in the multi component liquid for providing a long lasting smell on such assailant when sprayed with such multi component liquid.

Such spraying dispenser 2 is selected from a group including a pen 12, water bottles 14, a fake gun 16, a canister 2, a household spray 18 and baby shampoo bottles 22.

It is presently preferred that such staining material is a reflective paint which can be seen clearly in the daylight and glows in the dark and, further that such reflective paint can only be removed by using a specialized formula. Therefore, such assailant would be marked for easy detection since such specialized formula would not be available to the assailant. The multi component liquid also includes a pungent odor carrying component would also clearly identifies such assailant.

Such canister type dispenser 2 includes not only a spraying nozzle 4 for spraying such assailant but also includes an optional two way spray nozzle 6 wherein such victim would also be marked by a small amount of liquid as one of proof and as evidence, if necessary, to prove that an attack occurred.

Thus, the present invention provides a spray liquid which emits a visible stain to the skin or clothing and, further, produces a skunk like odor on a would be assailant. The liquid is a type or reflective paint that when sprayed can be seen clearly in the daylight and glows in the dark. The liquid can be sprayed from any household dispenser, such as a pen, water bottle, a fake gun, perfume sprayers, baby shampoo bottles or anything that effectively ejects a liquid. The only way to remove the ink or stain and odor is by using a specialized formula specifically designed for the removal of reflective paint. In another embodiment there is a design for a two-way spraying dispenser which would not only spray the attacker but would mark the victim as well. The victim would only be sprayed with a minute amount of liquid as proof or evidence, if that is necessary. Since crime is universal this invention could be used anywhere. Spraying the attacker would clearly identify the attacker and may possibly prevent the attacker from perpetrating another crime since the attacker is already clearly marked. The spray could benefit anyone who uses it and possible create a more proactive atmosphere of crime prevention.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for providing a form of defense and protection from would be assailants, said apparatus comprising:
(a) a spraying dispenser having a predetermined shape and formed of a predetermined material;
(b) a multi component liquid disposed within said spraying dispenser, said multi component liquid including a staining material; and
(c) a pungent odor carrying component disposed in said multi component liquid for providing a long lasting smell on said assailant when sprayed with said liquid.

2. The apparatus, according to claim 1, wherein said spraying dispenser is selected from a group including a pen, water bottles, a fake gun, a canister and baby shampoo bottles.

3. The apparatus, according to claim 1, wherein said staining material is a reflective paint which can be seen clearly in the daylight and glows in the dark.

4. The apparatus, according to claim 1, wherein said reflective paint can only be removed by using a specialized formula, therefore such assailant would be marked for easy detection.

5. The apparatus, according to claim 1, wherein said pungent odor carrying component would also clearly identify such assailant.

6. The apparatus, according to claim 1, wherein said spraying dispenser further includes an optional two way spraying dispenser wherein such victim would also be marked by a small amount of liquid as one of proof and as evidence, if necessary, to prove an attack occurred.
